(19) United States
(12) Patent Application Publication
(10) Pub. No.: US 2004/0201878 A1
(43) Pub. Date: Oct. 14, 2004

(54) Electrooptic devices

(75) Inventors: Anoop Agrawal, Tucson, AZ (US); Juan Carlos Lopez Tonazzi, Tucson, AZ (US)

Correspondence Address: Anoop Agrawal, ENKI TECHNOLOGIES LLC, 4541 East Fort Lowell Road, Tucson, AZ, 85712, US

(73) Assignee: ENKI TECHNOLOGIES LLC

(21) Appl. No.: 10/626,755

(22) Filed: Jul. 24, 2003

Related U.S. Application Data
(60) Provisional application No. 60/398,651, filed on Jul. 25, 2002.

(51) Int. Cl. G02F 1/155

(52) U.S. Cl. 359/266

(57) ABSTRACT

This invention discloses novel ways of making electrooptic devices where the electrodes are made from conductive yarns. This allows fabrication of flexible and large area devices at an attractive cost. Applications of these devices are in displays, large-area variable optical transmission panels and for optical emmisivity control

### CROSS REFERENCE TO RELATED APPLICATIONS

This application claims benefit of and priority to U.S. provisional application 60/398,651 filed on Jul. 25, 2002.

### TECHNICAL FIELD

This invention is relates to the field of electrooptics, electrochemistry and manufacture of electrooptic devices. The application of these devices are in displays, large-area variable optical transmission panels and for optical emmisivity control.

### BACKGROUND OF THE INVENTION

Electrooptic devices are used for many purposes. Some of the preferred applications of devices from this invention are devices for architectural, transportation and camouflage uses. The resulting devices may be flexible or rigid and are easy to scale to large areas. Some examples of preferred electrooptic devices are electroluminscent (EL) and electrochromic (EC) and photoelectrochemical (PEL) (e.g., user controllable photochromic device) and suspended particle devices. The EC devices are used to change the transmission/reflection properties of light. Light refers to electromagnetic radiation primarily in UV, visible and the infra-red. In some specific cases this would also cover radio and microwaves. For camouflage and space applications particular interest is in reversibly changing the emissivity of the devices in the infrared region.

Several constructions of EC devices will be described to enable one to appreciate the utility of the current invention. Typical constructions of these devices and their working principles are described in Cronin et. al.(1999) and in Lynam et. al. (1990). Electrochromic devices are generally constructed using two opposing electrodes which are largely coplanar. Opposing means that these are of opposite polarity to electrically activate the device. The electrochromic activity takes place at the surface of these electrodes or on the layers deposited on them. FIG. 1 shows an EC device constructed using two substrates 10. Each of which is coated with a conductive coating 12, at least one of the combination of the substrates and the conductive coating is transparent for a window or a mirror application. The electrodes may be conductive layers on non-conductive substrates or they may simply be a conductive material. The electrolyte 13 consists of a solvent comprising of at least a solubilized redox dye system. As an example the redox system may be a mixture of a cathodic dye “C” and an Anodic dye “A”. When a potential difference is applied at the two electrodes, the cathodic dye reduces at the cathode resulting in a colored species. The anodic dye oxidizes at the anode which may also be colored. At least one of the cathodic or the anodic dyes in their respective reduced or the oxidized state should be different in color to change the optical properties of the device. The change in color refers to a change in transmission, reflection or emission change in any region of the electromagnetic spectrum defined above. The presence of the reduced and oxidized species gives the device its color. In some instances the anodic and the cathodic functions of the dye are combined in one molecule. The details of these devices and other additives such as supporting salt, UV stabilizer, viscosity modifier and other dyes are described in several other publications which are incorporated herein by reference (US patent application 2002/0012155, U.S. Pat. No. 5,725,809, U.S. Pat. No. 4,902,108, and U.S. patent application Ser. No. 10/600,807 filed on June 20, 03).

Another EC device is shown in FIG. 2 where the device is made using substantially coplanar substrates 20 coated with conductive layers 21. One of these layers is further coated with a layer 24 which is able to electrochemically reduce and/or oxidize. For example, if this layer is reduced (cathodic) in the device to change its color, then the complementary dye added to the electrolyte 23 should oxidize (anodic), conversely if an anodic layer is used then the dye added to the electrolyte should at least be able to react through a reduction (cathodic) process. It is not necessary that both the anodic and the cathodic components have to be electrochromic (i.e., they both change their optical properties when oxidized or reduced) but both must be electrochemically active. Examples of anodic EC layer is polyaniline and examples of cathodic electrochromic layers are tungsten oxide and polyethyelenedioxythiophene (PEDOT). Examples of cathodic dyes are viologen salts and examples of anodic dyes are ferrocenes, phenothiazines, etc. These materials mentioned here may be used as mixtures, compounds or their derivitized forms.

One of the disadvantage in scaling these devices to large sizes (e.g. one square feet or larger) is the conductivity of the transparent conductor, and its cost. Most commonly used transparent conductors such as indium/tin oxide and fluorine doped tin oxide are either expensive or low in conductivity. These transparent conductors when available on glass increase in their price substantially when their resistivity drops from about 10 ohms/square. Use of low-resistivity conductors lowers the speed of EC device change. For flexible devices if plastics are used then the conductivity of transparent conductors is even poorer as high temperature processes (typically higher than 300C) to deposit them cannot be used, and in addition their thickness has to be low due to expansion mismatch with plastics substrates. Thus it is desirable to be able to make electrooptic devices where the conductivity of the electrode conductors can be increased and/or use of plastics substrates can be enabled. Use of plastics also results in more impact resistance devices as compared to those using glass substrates. Many of the solvents used in electrochromic and other electrochemical devices may corrode or solubilize many common plastics materials. Some of these liquids are gamma-butyrolactone, propylene carbonate, tetraglyme and sulfolane. These liquids are also hygroscopic, contribute towards flammability of the device and are susceptible to UV from a long term durability perspective. Thus for some applications it would be desired to use liquids in electrolytes which overcome these limitations.

Many new applications could be realized if flexible devices can be made in large areas at an attractive cost. For example electroluminescent devices can be made for large flexible signage and displays. Flexible large EC devices may be made for active camouflage that may be used to cover military or other sensitive installations and objects such as wearable textiles, tents, vehicles, planes, boats, armor, etc. Such covers may be used in patches or as a continuous sheet. Skins or covers that could change their emissivity are also useful for space applications where the temperature control of the space ship is important with least amount of energy input. These may also be used in translucent composite structures used for making variable transmission panels for skylights, building walls, curtain walls, etc. Examples of these structures are sold by Kalwall (Manchester, N.H.) and also under the name Skywall from Vistawall (Terrell, Tex.). These are fabricated by using two rigid translucent plates, typically made from fiber reinforced polymer, which are spaced apart in a parallel geometry. The space between these plates is filled by insulating glass fibers which are typically colorless or white in appearance. All of this is then set in frames. The electrooptic structures of this invention may be sandwiched between the two rigid outer skins of the translucent panels described above.

### BRIEF SUMMARY OF THE INVENTION

The objective of this invention is to enable electrooptic devices which are made by using at least one of the electrodes comprising of conductive yarns. In addition electrolytes comprising of ionic liquids will be described which result in several benefits, particularly for use with plastics substrates. This invention overcomes several limitations of prior art in making flexible devices and also devices which may be made in large areas. Processing methods to make such devices are also disclosed.

### DESCRIPTION OF THE FIGURES

FIG. 1: Schematics of an EC device with redox electrolyte.

FIG. 2: Schematics of an EC device with a redox layer and a redox electrolyte.

FIG. 3: Schematics of a woven fabric cross-section.

FIG. 4: Schematics of a woven fabric with electrical connections.

FIG. 5: Schematics of a fabric cross-section made with coated yarns.

FIG. 6: Schematics of a fabric cross-section incorporated between two sealing layers.

FIG. 7: Schematics of a fabric device in the colored state.

FIG. 8: Schematics of an EC device with electrodes on different fabrics.

FIG. 9: Schematics of an EC device with coated electrodes on different fabrics.

FIG. 10: Schematics of a device with bond points.

### DETAILED DESCRIPTION OF THE INVENTION

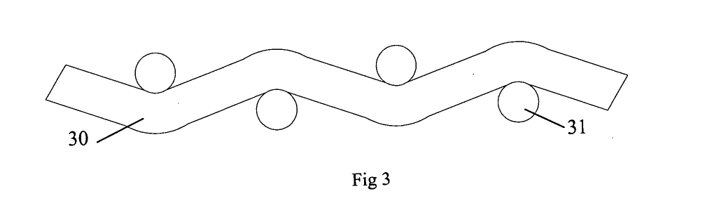

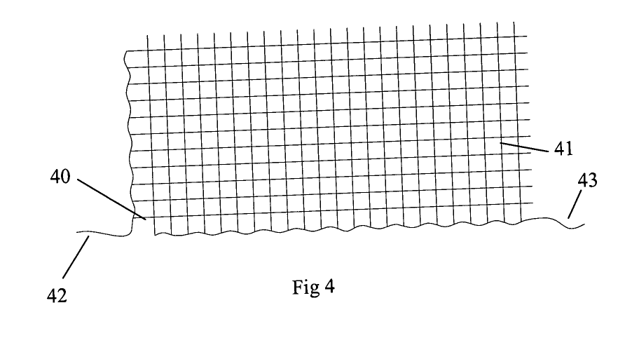

One novelty of this proposal resides in the electrode structure comprising of yarns. Yarns are generally textile structures which may be spun or extruded. These may be composed of short fibers, continuous filaments and short fibers together or only of continuous filaments. The yarn may comprise of monofilaments or have several filaments. One of the important aspects of this invention is flexibility of the devices, thus it is preferred to use flexible yarns. The yarns are considered flexible if a 15 cm long yarn is held from its bottom end in a vertical position and it bends by 90 degrees or more under its own weight. An example of a device is described in FIG. 3 which shows a woven textile structure in cross-section with the two cross yarns, namely warp 31 and the weft 30 of a fabric. A plan view of this fabric is shown in FIG. 4. These yarns comprise of electrically conductive materials including those yarns which are coated with electrically conductive materials. These yarns form the electrodes for the device where the weft 40 are connected to one terminal 42 and the warp 41 to a terminal 43 of opposite polarity to activate the device electrically. If conductive parts of these yarns are on the surface then two sets of yarns will electrically short, i.e., the conductive layer of the cathode and the anode will touch. Thus an insulating coating is deposited on the surface of the yarns before weaving into a fabric to avoid electrical shorting. However as discussed later this coating must be able to acquire electrolytic properties (or be porous to support an electrolyte) when used in a device.

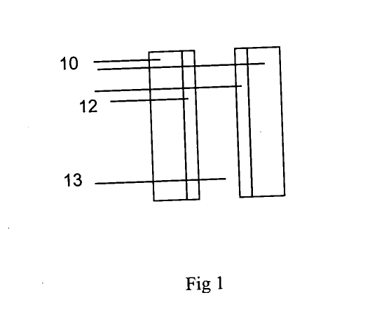

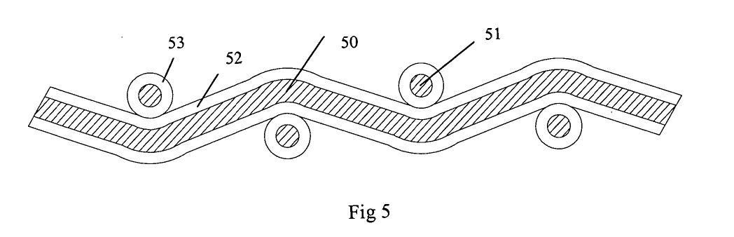

For example in FIG. 5, the opposing electrodes are also warp and weft respectively. These conductive yarns are coated with non-electrically conductive polymeric electrolytic layer before they are assembled (woven) into a fabric, to avoid the electrical shorting between the two opposing electrodes. Only one set, the warp or the weft needs to be coated, however, coating both sides, further reduces the inadvertent possibility of electrical shorting. Standard coating processes used in the textile industry may be used to coat the yarns before they are converted to a fabric. One such process is a “sizing process” where the warp is coated to increase its strength, and to reduce friction during the weaving process (Vigo, T. L (1994). The coating may be an electrolyte or it may not have electrolytic properties as deposited on the yarns, but has the property that it would be able to absorb the electrolyte or components thereof in a latter process so that it may acquire electrolytic properties. U.S. Pat. No. 5,216,536 describes electrolytic materials which are depositable from a liquid and later solidified by cross-linking. The layer on the yarns may also comprise of spacers such as polymeric particles (e.g., latex), glass beads, or a wrapping (or twisting) of a porous structure (such as another spun or textured yarn from a non-conductive organic fibers) around the conductive yarns which may absorb the electrolyte. This device is similar to the one shown in FIG. 1 where at several points, the electrolyte (52 and 53) is pinched between the two electrodes (50 and 51). After weaving the fabric, a finish (a coating) is applied (not shown) to protect the structure from moisture and oxygen. Again this may be accomplished by using processes which are standard in the textile industry where the fabrics are immersed through a liquid bath such as desizing, application of dyes, mercerizing and waterproofing.

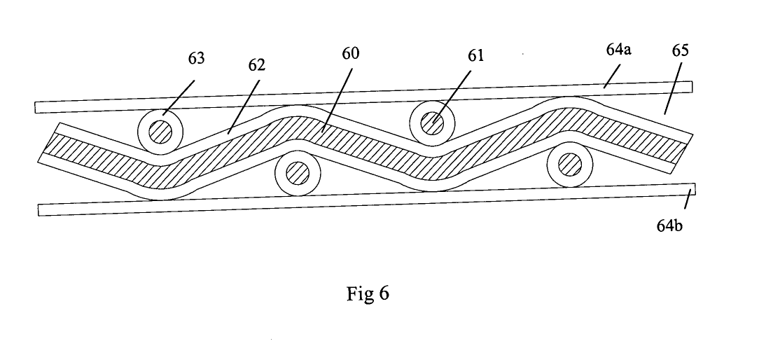

As shown in FIG. 6, instead of applying the impermeable finish, the structures could be encapsulated in polymeric films or glass sheets (protective layers) 64a and 64b which provide the barrier characteristics. These could be thin (less than 1 mm thick, preferably less than 0.1 mm thick) and flexible. These could be transparent or translucent and one of these may even be opaque which could be one of absorbing or reflective. As explained earlier, 60 and 61 are conductive electrodes and 62 and 63 are the electrolytic layers. Here all the electrochromic activity is between the sheets (layers) 64a and 64b, but the sheets themselves do not have to be electrically conductive. The edges of the encapsulating sheet may be sealed by an adhesive or by heat-sealing the sheet itself. The ends of the connectors (e.g. as shown in FIG. 4 as 42 and 43) could be threaded or projected through this area before sealing. The sealant also forms a seal around the connectors so that there is no physical ingress into the device through this area.

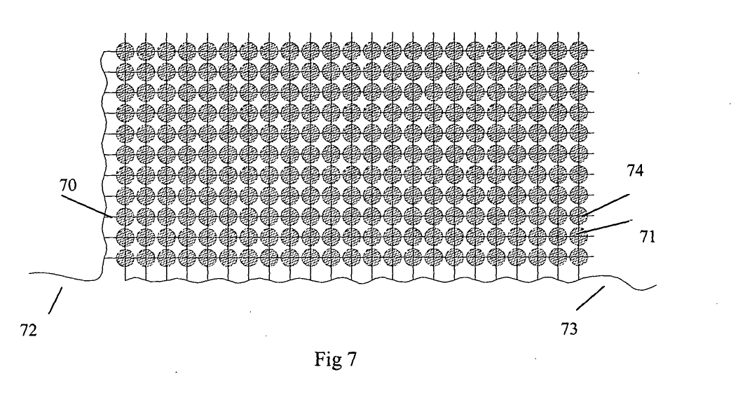

The schematics shown in FIG. 6 can also be used for yet another novel variation where the space 65 is filled with an electrolyte. This filling is generally preferred after encapsulating the electrodes. The liquid electrolyte is inserted through a small hole (generally between 0.1 to 10 sq mm) in one of the substrates or in the perimeter seal into the encapsulated area. This inlet is then sealed after the injection of the electrolyte. The electrodes or the yarns are coated with an insulating polymer which is compatible with a liquid electrolyte, i.e., the insulating polymer coatings (62 and 63) are able to swell after absorbing the electrolyte so that they also acquire the properties of the electrolyte. This polymer may itself be ion-conductive. An example of proton conductor is perfluorosulfonate polymer available under the trade name of Nafion® from Dupont (Wilmington, Del.). To construct this device, a fabric is woven out of electrode yarns coated with such a polymer. This fabric is then sandwiched between two sheets which may also be flexible with the desired barrier properties. A liquid electrolyte is introduced inside the sandwich, which permeates through the residual interstices in the fabric and the compatible polymer. This electrolyte may even be polymerized later as an option. When the device is powered (shown in FIG. 7) using the electrical connections 72 and 73, the dyes in the electrolyte in contact with the electrodes colors which then migrates away from the electrodes into the surrounding electrolyte resulting in a hue change. The color will be most intense at the points where the warp 71 and the weft 70 intersect (e.g., 74), which gradually fades away as one moves from this intersection. This is shown schematically in FIG. 7 (compare this with bleached state of the device in FIG. 4). The electrode concepts shown in FIGS. 4 through 6 comprising of single fabrics are also novel for primary and secondary batteries. For batteries these may be used in a planar mode or rolled up in a cylindrical form and inserted into a “can”. Analogous to FIG. 6, the “can” becomes the protective layer.

To make an electrical connection at the edge of the fabric, the tips of the warp and the weft may be stripped of the coating to expose the conductive part which is then connected to the electrodes as shown in FIGS. 4 and 7. If the tips of the yarns are stripped of the coating, it is preferred that these areas be outside of the device. The perimeter sealant will have to ensure that there is no physical ingress into the device from around these yarns. An advantage of the fabric shown in these figures is that it may be cut in the field to size, the tips of the fibers stripped and then connected. If plastic sheet is used for barrier which is also cut open in the process, then it may require re-sealing. These may also be integrated with clothing as one or more patches, labels by using conductive yarns using standard embroidery procedures as disclosed by Post, et al (2000) which is included here by reference.

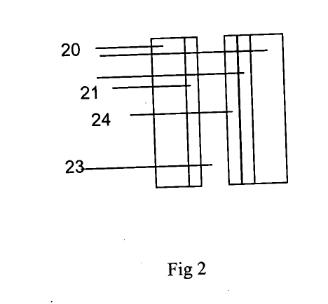

To make a device based on the principles of FIG. 2, at least one set of yarns is coated with an electrochemically active layer. Electrochemically active layer is one which participates in an electrochemical reaction and is reversibly oxidized and reduced. For example in FIG. 5 one of the coatings 53 or 52 forms the electrolytic layer and the other one is electrochemically active, which may also be electrochromic. The yarn which is coated with the electrochemically active layer may further be coated with an electrolytic layer as an option.

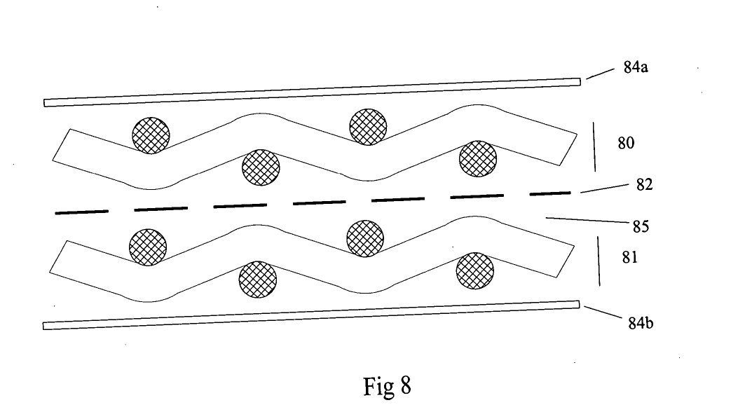

In a variation of this invention individual fabrics may be used as distinct electrodes. These fabrics are largely permeable to diffusion of the redox materials and ions and may even be permeable to the electrolytic solvent and other additives in the electrolytic mixture. FIG. 8 shows an example where a three layered fabric with open structure constitutes an active part of the device. Also shown are the non-permeable encapsulating sheets (layers) 84a and 84b. The two conductive fabrics 80 and 81 are the two electrodes. Fabric or a porous layer 82 is electrically insulating which keeps the two electrodes from shorting, but it conducts ionically or supports an electrolyte. A liquid electrolyte 85 containing redox species (redox species are dyes which undergo reversible oxidation and reduction and may also be electrochromic) is poured which permeates through the fabric structures and fills the cavity between the two non-permeable sheets 84a, b. When a voltage is applied, the colored redox species spread away from the electrodes, thus resulting in a color change. In another variation the inward surfaces of the sealing sheet may have a transparent conductive coating preferably in a range of 10 to 1000 ohms/square. The conductive electrodes may be loose net fabrics to carry most of the current, where such fabrics will touch the two respective surface conductive coatings. The conductive coatings generally provide localized conductivity in those device areas which are between the meshes of the fabric. Further, the separator or the electrolytic fabric could be dense to a point that it obscures the conductive fabric lying below it.

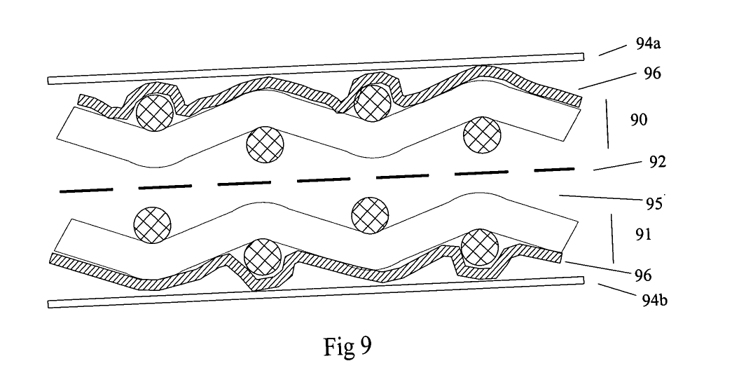

Those EC devices which contain electrochemically active layers on both electrodes can also be fabricated using this invention. The electrolyte is only used to conduct ions. These devices are described in publications cited earlier (Cronin et. al.(1999) and in Lynam et. al. (1990). These coatings may be on conductive fabrics or even on the non-permeable sheets. In the latter case the non-permeable sheets should have a conductive layer underneath and the conductive fabric touches these layers as well. A device with two coated fabrics is shown in FIG. 9. The fabrics 90 and 91 are coated with electrochemically active layers 96 and 97 respectively. At least one of these has to be electrochromic and both may even be the same. These are separated by non-electrically conducting porous sheet 92 (which could also be a fabric, e.g. see U.S. Pat. No. 5,995,273 for examples of electrolyte permeable layers). These are encapsulated between two non-permeable sheets 94a and 94b. The space between these sheets is filled with a liquid electrolyte 95 which could later be cured to a solid. The electrolyte may only be a ionic conductor, e.g., aqueous solution with salt or a non aqueous medium with lithium ions, etc. These layers may be deposited by silk screening so that substantially one side of the fabric is coated. The separator 92 may have sufficient hiding power so that only one fabric is visible when one looks from either side normal to the impermeable sheet. If 96 and 97 are the same, one may color 96 and bleach 97 and vice versa. Since only one side is visible at a time, it results in change of appearance of the device from any of the sides. Pastes for silk screening may be made using polymeric binders (for example fluorinated elastomers) and powders of electrochromic materials (organic and inorganic), some of these principles are described in U.S. Pat. Nos. 6,165,388 and 5,500,759, which are incorporated by reference herein. The fabrics or yarns may also be coated using wet-chemical technology, where these are passed through a liquid precursor and after that these are treated by radiation and/or heat to form the desired material. Formulations to deposit tungsten oxide at low temperatures from wet-chemistry are given in U.S. Pat. Nos. 5,525,264; 5,277,986 and in U.S. Pat. No. 5,252,354. Some of the electrochromic materials are tungsten oxide, antimony doped tin oxide, polyaniline, polythiophene, etc. Tungsten oxide and several conductive polymers are known for their reversible change in optical properties when they are reduced or oxidized. These materials are also used for change in their emissivity in a wavelength of about 3 to 20 micro-meters (e.g., see Trimble, C., et. al (1999) and Chandrasekhar, P., et. al (2002))

Yet, in another variation of this scheme only the top part of only one of the conductive fabrics (i.e., facing the sealing sheet) is coated with an electrochromic material. This device will be similar to FIG. 9 in construction but without layer 97. When the device is activated, this layer colors with a balance reaction taking place due to a redox dye in the electrolyte This device is preferably viewed from the side which has coated electrode.

Another alternative device construction may involve only one fabric which constitutes one electrode. The second electrode may be a foil, this foil may be made out of metal plate, metal film or a polymer sheet (or plate) coated with a conductive layer which may also be metallic. As an example consider device in FIG. 8, where the fabric 81 and the barrier layer 84b are replaced by a metal foil which results both in a barrier and an electrode. In this example the device is viewed only from the side of the layer 84a. In an extension of this concept, the foil may serve both as a reflector and an electrode. Some examples of preferred metals are nickel, stainless steel, silver, gold, aluminum, tantalum, niobium, rhodium, chrome, silicon and their alloys. Sometimes metals may participate in electrochemical reactions or be reactive with the electrolyte reducing the device lifetime. In such cases multiple layer structures may be used where a more noble metal may be put on the top which will contact with the electrolyte. One may even cover the metal with coatings of conductive inorganic oxides such as zinc oxide and indium/tin oxide.

Integration of conductive yarns in fabrics may be done in many ways. One method is to form the fabric using such yarns. Another one may be to bond the conductive yarns to a pre-formed fabric by a stitching mechanism or using an adhesive. The fabric structure may be tailored to give specific results. Weave type and the density of the fabric may be changed to suit the application. The preferred weaves are plain, twill and satin. For example preferred twills may range from 2/1 to 16/1. These may absorb the electrolyte to change the fabric appearance Examples of porous yarns are those made from textured or spun fibers. There could be several variations to these schemes. Between each of the warp and the weft additional organic yarns with none or little electronic conductivity may be interleaved only to physically carry (or absorb) the electrolyte and not be electrically conductive. Each yarn may be a mixture of conductive and non-conductive filaments, or different fabric structures (Adanur, S. (2001), e.g., plain, satin or twill weave, knitting, non-wovens or even patched designs may be used to obtain the desired variation in hue and appearance of the finished product. In one variation electrodes may only be one of warp and weft but the alternate yarns in a given set form opposing electrodes. In another variation after the coating, the yarns forming the opposite polarity could be twisted together, with or without non-conductive yarns. One has to ensure that surface coatings on the yarn will prevent shorts as described earlier. These yarns can be woven into fabrics. The twisted yarn will have to be separated at the edges of the fabric to separate anode from the cathode. Yarns may also be employed which have a geometry akin to a braided coaxial cable, where an inner conductor is surrounded by a electrolytic layer on top of which is a braided metal electrode. In this case it is preferred to have a loose or a low density braid so that the electrolyte is visible to see optical changes emanating in the electrolyte or on the surface of the inner electrode. One may add fillers to the electrolyte such as titania particles to hide the inner electrode and only make the changes on the surface visible. The fabric could be designed with patterns, which are differentiated by differences in weave. These patterns manifest differently when the fabric is colored. Further, all weft and warp may not be powered simultaneously, but in a sequence where a few are colored in a predetermined pattern or a random pattern to be able to change the pattern dynamically.

Fabric density relates to the looseness of the fabric structure, i.e., the number of warp and the weft per linear inch. The fabrics may be high in density or be like loose nets. It is generally preferred to keep the opening between adjacent yarns in a fabric to about less than 10 times the width (or the diameter) of the yarn. Further yarns with weights of less than 1 kg/km are preferred. The fabrics may employ loops and as in carpets. The fabric structures may also be knitted. One may use a pair of yarns to form the knitted structure. These yarns are coated as discussed above to avoid shorts as one will be anode and the other cathode. In a variation, this may be a multifilament twisted yarn, where about half of these are anode and the other half cathode.

The use of conductive yarns takes a major hurdle out of the technology where devices are limited in size and/or performance due to non-availability of highly conductive but transparent conductors on plastic substrates. Since highly conductive yarns may be used (as discussed later), this assembly eliminates the bottleneck due to the non-availability of highly conductive transparent electrodes on plastics substrates.

There may also be fixed patterns coated on the outside or inside of the device (or anywhere which are not electrochromic). This is being called the first pattern. When the EC device colors in another pattern (called second pattern). The second pattern may be due to the electrode structure (i.e. yarn arrangement), and/or transient pattern in coloring. Light which is transmitted or reflected through the device interferes with the first and the second patterns and a third pattern is formed due to moire fringes. More on the concept of moiré fringes is given in PCT application WO 01/90809 which is included herein by reference. The concept of dynamic moiré fringes is particularly attractive for active camouflage. The first pattern may be exterior to the device which may even be oscillated mechanically to vary the moiré fringes.

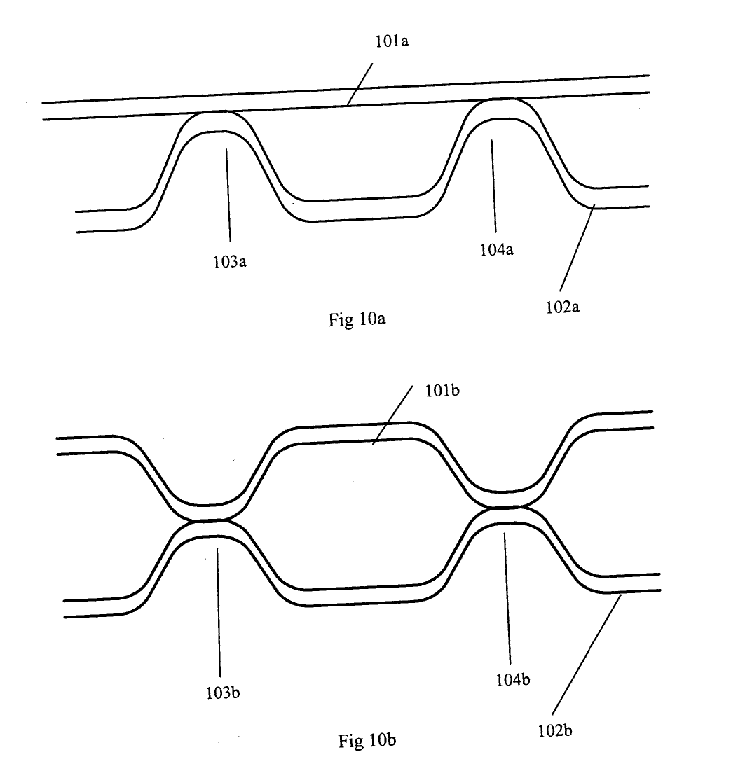

Devices which are flexible and use liquid or low-strength solid-electrolytes, may need reinforcement against deformation. For example a large device such as one square foot or bigger may deform in vertical placement where the electrolyte may accumulate at the bottom due to the ballooning (or deformation) of the substrates. A preferred strengthening method is to periodically bond the outer skins together throughout the interior of the device. This may be done by using adhesive, thermal fusion, stitching or any other method. FIG. 10 shows schematically a device where the outer skins are 102 and 101. Interior electrodes. etc., are not shown. These are bonded (bond points) at 103 and 104. These bonds may be formed by fusing 101 and 102, or another material placed inside the device. The bonding may be of the outer layers or they may be bonded to and around the yarn electrodes. These bond points may be created before the introduction of the electrolyte or after the device assembly is complete. These bond points may be a few inches apart, or they may be spots or lines. Lines may even divide the device in independent compartments so that failure in one compartment may not result in complete failure of the device. The lines may even be used to physically divide the device. These bonding lines may also be conveniently used to run the electrical busbars.

Conductive yarns to construct these fabrics are available in a variety of configurations. Some of the non-exhaustive choices are:

Yarns from continuous metallic fibers (or wires)

Organic fibers coated with metals

Metal fibers spun into yarns along with organic fibers

The metals used in the application should not be electrochemically active, unless the coating participates in the reaction and a device shown in FIG. 2 is intended. Some of the preferred materials are aluminum, silver, tantalum, niobium, platinum, gold, nickel, chromium, rhodium, stainless steel and their alloys. Conductive carbon or graphite fibers may also be used. To keep the economics of the system attractive, of these the preferred choices are chromium, nickel and stainless steel. Stainless steel yarns and yarns with stainless steel slivers along with the other organic fibers such as nylon are available from Bekaert Fiber Technologies (Marietta, Ga.) under the trade name of Bekinox® and Bekintex®. Bekinox are metal fibers with various compositions and the latter ones are blends of organic and metal fibers. Some of these are Ni, Ni—Cr, Ni—Cr—Mo, Ni—Cr—Fe, Ni—Cr—Mo—Al, Ti and Cr—Al. Also organic fibers coated with nickel are available from Dupont under the trade name of Aracon®. Another advantage of this geometry is their high conductivity which may be achieved as compared to coated substrates. The conductivity of the electrodes in these fabrics are expected to exceed the best transparent conductive coatings on plastics by almost three orders of magnitude and more. As an example transparent coatings on plastics are generally in a range of 40 ohms/square or more. Aracon XNO200E-025 has a DC resistance of 9180 ohms/km length of fiber. When 26 yarns/cm of yarns are laid out to make a fabric, each layer (weft or warp) will have a conductivity in the yarn direction of about 0.005 ohms/square. As another example a scrim fabric made out of Aracon XN0400EF-018 (2,300 ohms/km) with 6 yarns/cm, the fabric conductivity would be 0.004 ohms/square. For devices on fabrics it is preferred that the conductivity of either the warp or the weft or the fabric (if fabric is one electrode) should be less than 10 ohms/square to make the devices of this invention and more preferably less than 1 ohm/square. Since, the EC devices are current consuming devices, the low conductivity of the transparent conductors results in large ohmic drop towards the device center with increasing device size. Since, the applied voltages are not transmitted to the device center, the devices do not color in the center as deeply. Thus, the use of conductive yarns will also resolve the issue of size scale-up where very large structures could be made without encountering the voltage drop. The yarns may have other geometries, e.g., flat ribbon shaped material, e.g., ribbons cut out of metalized polymeric sheet.

Monomers (including co-monomers and catalysts which polymerize and solidify the electrolyte) are important additions to the electrolytic mixture so that it maybe polymerized into a solid. These may be used in two ways. One for solidifying the electrolyte or polymeric coatings on the yarns and fibers, and second after a liquid electrolyte is introduced in a cavity (such as 65, 85 and 95 in FIGS. 6, 8 and 9 simultaneously) and it is absorbed by the components, it is solidified in place. The yarns will be coated or structures permeated and then the coating solidified by thermal process or a radiation exposure (e.g., UV). Although there are many classes of monomers which cross-link, the two which have been most successfully employed are based on acrylic and urethane chemistry. Momoners and catalysts are selected so that these do not interfere with the proper functioning of the device. These are described in the literature (U.S. Pat. No. 6,245,262, U.S. Pat. No. 6,245,262) which is enclosed by reference herein. Also, the electrolyte may be introduced at elevated temperatures which then permeates through the space and is solidified by cooling.

The electrolyte will typically consist of a suitable high boiling and high polarity solvent which could dissolve the supporting salts and the redox material(s). The high polarity solvent may be substituted completely or in part with an ionic liquid. Ionic liquids are salts which have their melting point below the use temperature, e.g. room temperature. Since, hydrophobic ionic liquids may be chosen which will solubilize redox ingredients, the need for water barrier requirements may be relaxed. This allows a variety of plastics substrates to be used without the fear of being attacked by the conventional solvents. Further, it has been also shown that the degradation due to oxygen in ionic liquids is also much lower, where the devices were prepared under ambient conditions (see PCT application WO 02/053808). Examples of high boiling point and high polarity liquids are gamma-butyrolactone, propylene carbonate, tetraglyme and sulfolane. Preferred examples of ionic liquids are based on cations of quarternary ammonium and anions of fluorinated materials (Sun, J. et. al. (1998). Preferred cations of the ionic liquid solvent include lithium cation and quaternary ammonium cations, where preferred quaternary ammonium cations are pyridinium, pyridazinium, pyrimidinium, pyrazinium, imidazolium, pyrazolium, thiazolium, oxazolium, triazolium, tetraalkylammonium, N-methyl morpholinium, cations of the formula [(CH₃CH₂)₃N(R₁)]⁺, wherein R₁ is alkyl having 2-10 carbons, cations of the formula [(CH₃)₂(CH₃CHCH₃)N(R₂)]⁺, wherein R₂ is alkyl having 2-10 carbons, cations having the structural formula

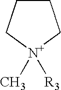

wherein R₃ is alkyl having 2-10 carbons, and cations having the structural formula

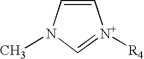

wherein R₄ is alkyl having 2-10 carbons, and preferred anions include trifluoromethylsulfonate (CF₃SO₃⁻), bis(trifluoromethylsulfonyl)imide ((CF₃SO₂)₂N⁻), bis(perfluoroethylsulfonyl)imide ((CF₃CF₂SO₂)₂N⁻) and tris(trifluoromethylsulfonyl)methide ((CF₃SO₂)₃C⁻). In addition, as the components of the solvent are ionic, they do not evaporate and have negligible vapor pressure, thus eliminating the issue of emissions (Gordon, (2001); Earle (1999); PCT patent application WO 01/93363 (2001)). Typical ionic liquids have low solubility for common transparent plastics such as polymethylmethacrylate, polystyrene, polycarbonate, polyester (polyethylene terephthalate and polyethylene naphthalate), polyimide and polysulfone, fluropolymer (e.g., Aclar from Honeywell). Thus, use of plastic substrates with ionic liquids in electrolytes is compatible. UV stabilizers may be added to the plastic substrates to block UV and/or they may be added to the electrolytes as well. If ion containing dyes and salts are used in electrolytes, then it is preferred that the anions of these materials are same as that of the ionic liquids. More on this and preferred dyes, and other additives for electrolytes with ionic liquid are given in U.S. patent application Ser. No. 10/600,807 filed on Jun. 20, 2003, which is included herein by reference in its entirety. One of the most preferred ionic liquid is Butylmethylpyrrolidinium bis(trifluoromethylsulfonyl)imide (BMP). It was seen that this solvent did not corrode a piece of polymethylmethacrylate (PMMA), whereas propylene carbonate (PC) (a common solvent for EC devices) solubilzed and stained PMMA. Further a mixture of 60% BMP and 40% PC (by volume) also had no effect on the PMMA substrate.

These principles may also be used to make electroluminscent and other electrochemical devices which are based on similar construction, such as by substituting the redox EC dyes with electrochemically regenerable chemiluminscence dyes. Such devices are called in the literature as electrogenerated chemiluminscence or light emitting electrochemical cells (Electrochemical methods: fundamental and applications, Bard A. J et. al. (2001)). The light is emitted when the reduced and the oxidized species which migrate away from the electrodes recombine or the light is emitted at the points where the two electrodes come in contact, but the emitted light bleeds through the fabric structure. Some of these materials are dyes and also nano-particles of semiconductors. Examples of nanoparticles are elemental and compound semiconductors, such as silicon, germanium, cadmium selenide, cadmium sulfide, etc. (Ding, Z. et al. (2002). The size of nanoparticles is generally less than 10 nm, and more preferably less than 5 nm. These particles may be organically modified on the surfaces to avoid agglomeration and reactivity. These devices are typically based on constructions shown in FIGS. 1 and 2. Depending on the device the active materials may be in the electrochemical coating or in the electrolyte. Other dyes to enhance the effect such as amines and salts may also be present in addition to non-electrochemically active UV stabilizers. Dyes which emit in near IR may be added for making objects for use in special military operations. One example of such a dye is heptamethine cyanine dye (Lee S. K., et al. (1997)).

These devices may be integrated with sensors and electronics which could provide the feedback to change the appearance of the devices automatically. These may be fitted with sensory assistance for handicapped users or to free the sensors of the user such as eyes, ears and hands, etc. for an automatic response (Gemperle, F., et al., (2001). The power source may be batteries, mains or Solar cells, wind or energy derived from the mechanical motion of the device or the motion of the object using the device. One example being power generated by the motion of the person (e.g., piezoelectric power converters in shoes) who is wearing these devices.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

### REFERENCES

Patent Literature

Published US patent application 2002/0012155

U.S. Pat. No. 5,725,809,

U.S. Pat. No. 4,902,108

U.S. patent application Ser. No. 10/600,807 filed on June 20, 03

U.S. Pat. No. 5,216,536

U.S. Pat. No. 5,995,273

U.S. Pat. No. 6,165,388

U.S. Pat. No. 5,500,759

U.S. Pat. No. 5,525,264

U.S. Pat. No. 5,277,986

U.S. Pat. No. 5,252,354.

PCT application WO 01/90809

U.S. Pat. No. 6,245,262

U.S. Pat. No. 6,245,262

PCT application WO 02/053808

PCT application WO 01/93363

Non-Patent Literature

1. Cronin J. P., Gudgel T. J., Kennedy S. R., Agrawal A. and Uhlmann D. R., Electrochromic Glazing, Materials Research, Vol. 2, No. 1, (1999) p-1.

2. Lynam N. R., Agrawal A., Automotive Applications of Chromogenic Materials, in Large Area Chromogenics: Materials and Devices for Transmittance Control. Lampert C. M., Granqvist C. G., eds. SPIE, Optical Engineering Press, Bellingham, Wash. (1990) p-46.

3. Vigo, T. L., Textile Processing and Properties—Preparation, Dyeing, Finishing and Performance, Textile Science and Techonology Series-11, Elsevier, New York (1994).

4. Post, E. R., Orth, M., Russo, P. R., Gershenfeld, N., E-broidary: Design and Fabrication of Textile Based Computing, IBM Systems Journal, Vol 39, Nos 3 and 4, p-840 (2000).

5. Trimble, C., et. al., Thin Solid films, Vol 355-356, (1999) p-26.

6. Chandrasekhar, P., et. al., Adv. Funct. Mater. Vol 12, (2002), p-95

7. Adanur, S., Handbook of Weaving, Technomic, Lancaster, Pa. (2001)

8. Sun, J., Forsyth, M., and MacFarlane, D. R. Room-Temperature Molten Salts Based on the Quaternary Ammonium Ion, J, J. Phys. Chem. B, vol. 102, (1998), p-8858.

9. Gordon, C. M., New Developments in Catalysis Using Ionic Liquids, Applied Catalysis: General A, vol. 222, (2001) p-101.

10. Earle, J. M., Diels-Alder Reactions in Ionic Liquids, Green Chemistry, vol. 1 (1999) p-23).

11. Bard A. J., Faulkner, L. R., Electrochemical Methods: Fundamentals and Applications, second edition Wiley, New York (2001)

12. Ding, Z. et al, electrochemistry and electrogenerated chemiluminscence from silicon nanocrystal quantum dots, Science, vol 296, P-1293, (2002).

13. Lee S. K., et al, Analytical Chemistry, Vol 69, no 20, (1997) p-4126

14. Gemperle, F., et al., Design of a wearable tactile display”, Wearable computers, 2001. Proceedings of fifth international symposium on, IEEE computer Society, Las Alamitos, Calif.

1. An electrooptic device comprising of opposing electrodes separated by an electrolyte wherein at least one of the said electrodes comprises of electrically conductive yarns and the yarns are integrated in a fabric.

2. The electrooptic device in claim 1 is one of electrochromic, electroluminscent and photoelectrochromic and suspended particles.

3. An electrooptic device as in claim 2 which is used for a display, camouflage and a variable light attenuation panel.

4. An electrooptic device as in claim 1 is encapsulated between protective layers.

5. An electrooptic device as in claim 4 where the protective layers are made out of polymeric materials and the electrolyte comprises of ionic liquids.

6. An electrooptic device in claim 1 where the yarns are coated with an electrochemically active layer.

7. An electrooptic device as in claim 1 where the electrolyte comprises of at least one of a solvent, dissociable salt, ion-conducting polymer, redox dye, UV stabilizer, viscosity modifier.

8. An electrooptic device comprising of opposing electrodes separated by an electrolyte wherein one of the said electrodes comprises of electrically conductive yarns and the yarns are integrated in a fabric and the second electrode comprises of an electrically conductive foil.

9. An electrooptic device as in claim 8 where the foil is prepared by depositing a conductive material on an electrically insulating substrate

10. An electrooptic device as in claim 8 wherein at least one of the electrode is coated with an electrochemically active layer.

11. A method to prepare an electrooptic device comprising of opposing electrodes separated by an electrolyte wherein at least one of the said electrodes comprises of electrically conductive yarns and the yarns are integrated in a fabric, wherein the method comprises of:
a. assembling the electrodes connected to the powering leads between two opposing protective substrates; and
b. sealing the perimeter of the opposing protective substrates to encapsulate the electrodes with the ends of the powering leads projecting out of the encapsulation and with one or more holes in one of; the sealant and the protective substrate; and
c. introducing a liquid electrolyte through one of the said holes to fill the encapsulated volume, and sealing the holes after the electrolyte fill process is complete.

12. A method to prepare an electrooptic device in claim 11 wherein the liquid electrolyte is converted to a solid after the holes are sealed.

13. A method to prepare an electrooptic device as in claim 11 where prior to the electrolyte fill process bond points are introduced within the interior of the device.

14. A method to prepare an electrooptic device as in claim 11 where after the electrolyte fill process bond points are introduced within the interior of the device.
